(19) United States
(12) Patent Application Publication
(10) Pub. No.: US 2009/0184901 A1
(43) Pub. Date: Jul. 23, 2009

(54) ORGANIC LIGHT EMITTING DISPLAY AND DRIVING METHOD THEREOF

(75) Inventor: Oh-Kyong Kwon, Seoul (KR)

Correspondence Address: STEIN MCEWEN, LLP, 1400 EYE STREET, NW, SUITE 300, WASHINGTON, DC, 20005, US

(73) Assignees: Samsung SDI Co., Ltd., Suwon-si (KR); IUCF-HYU (Industry University Cooperation Foundation Hanyang University, Seoul (KR)

(21) Appl. No.: 12/186,013

(22) Filed: Aug. 5, 2008

(30) Foreign Application Priority Data
Jan. 18, 2008 (KR) 2008-5616

(51) Int. Cl. G09G 3/30

(52) U.S. Cl. 345/77

(57) ABSTRACT

An organic light emitting display includes a pixel unit including a plurality of pixels arranged at intersecting points of data lines, scan lines and light emitting control lines; a temperature sensor provided to measure a temperature of the pixel unit; a first analog/digital converter (first ADC) to convert information of the temperature measured in the temperature sensor into a first digital value; a controller to receive the first digital value outputted from the first ADC and outputting a control signal corresponding to the received first digital value; a sensing unit to extract a degradation level of an organic light emitting diode included in each of the pixels; a second analog/digital converter (second ADC) to receive information of the degradation of the organic light emitting diode extracted from the sensing unit and a control signal outputted from the controller and generating a second digital value corresponding to the information of the degradation of the organic light emitting diode that is varied according to the temperature; a conversion unit to convert an input data (Data) into a correction data (Data′) so as to display an image having uniform luminance regardless of the changes in the degradation level of the organic light emitting diode according to temperature, by using the second digital value outputted from the second ADC; a data driver to receive the correction data (Data′) outputted from the conversion unit and generating data signals to be supplied to the pixels.

### CROSS-REFERENCE TO RELATED APPLICATION

This application claims priority the benefit of Korean Patent Application No. 2008-5616, filed on Jan. 18, 2008, in the Korean Intellectual Property Office, the entire content of which is incorporated herein by reference.

### BACKGROUND OF THE INVENTION

1. Field of the Invention

An aspect of the present invention relates to an organic light emitting display and a driving method thereof, and more particularly, to an organic light emitting display capable of displaying an image having uniform luminance regardless of the degradation of the organic light emitting diodes by compensating for temperature effects, and a driving method thereof.

2. Description of the Related Art

In recent years, a variety of flat panel displays having reduced weight and volume, in comparison to the cathode ray tube (CRT) have been developed. The flat panel displays include liquid crystal displays (LCD), field emission displays (FED), plasma display panels (PDP), organic light emitting displays (OLED), etc.

Among the flat panel displays, the organic light emitting display uses an organic light emitting diode to display an image, the organic light emitting diode generates the light by recombining electrons and holes. Such an organic light emitting display has a rapid response time and is also driven by a low amount of power.

FIG. 1 is a circuit diagram showing a pixel of a conventional organic light emitting display

Referring to FIG. 1, the pixel 4 of the conventional organic light emitting display includes an organic light emitting diode (OLED) and a pixel circuit 2 coupled to a data line (Dm) and a scan line (Sn) to control the organic light emitting diode (OLED).

An anode electrode of the organic light emitting diode (OLED) is coupled to the pixel circuit 2, and a cathode electrode of the organic light emitting diode (OLED) is coupled to a second power source (ELVSS). Such an organic light emitting diode (OLED) generates light having a predetermined luminance using an electric current supplied from the pixel circuit 2. When a scan signal is supplied to the scan line (Sn), the pixel circuit 2 controls the current capacity supplied to the organic light emitting diode (OLED) which corresponds to a data signal supplied to the data line (Dm).

For this purpose, the pixel circuit 2 includes first and second transistors (M1 and M2) and a storage capacitor (Cst). The second transistor (M2) is coupled between a first power source (ELVDD) and the organic light emitting diode (OLED), and the first transistor (M1) is coupled between the second transistor (M2), the data line (Dm) and the scan line (Sn). The storage capacitor (Cst) is coupled between a gate electrode of the second transistor (M2) and a first electrode of the second transistor (M2).

The gate electrode of the first transistor (M1) is coupled to the scan line (Sn), and the first electrode of the first transistor (M1) is coupled to the data line (Dm). A second electrode of the first transistor (M1) is coupled to one side terminal of the storage capacitor (Cst).

Here, the first electrode is set to be one of a source electrode and a drain electrode, and the second electrode is set to the other electrode that is different from the first electrode. For example, if the first electrode is set to be a source electrode, the second electrode is set to be a drain electrode. The first transistor (M1) coupled to the scan line (Sn) and the data line (Dm) is turned on when a scan signal is supplied from the scan line (Sn), and supplies a data signal supplied from the data line (Dm) to the storage capacitor (Cst). At this time, the storage capacitor (Cst) is charged with a voltage corresponding to the data signal.

A gate electrode of the second transistor (M2) is coupled to one side terminal of the storage capacitor (Cst), and the first electrode of the second transistor (M2) is coupled to the other side terminal of the storage capacitor (Cst) and the first power source (ELVDD). The second electrode of the second transistor (M2) is coupled to an anode electrode of the organic light emitting diode (OLED).

The second transistor (M2) controls the current capacity that flows from the first power source (ELVDD) to the second power source (ELVSS) via the organic light emitting diode (OLED) which corresponds to the voltage value stored in the storage capacitor (Cst). Therefore, the organic light emitting diode (OLED) generates the light corresponding to the current capacity supplied from the second transistor (M2).

However, in the conventional organic light emitting display it is impossible to display an image having a desired luminance due to the efficiency change caused by the degradation of the organic light emitting diode (OLED).

In fact, the organic light emitting diode (OLED) is degraded with time, and therefore light having gradually decreasing luminance is generated in response to a same data signal.

Also, the degradation level of the organic light emitting diode (OLED) may vary according to temperature, and therefore the temperature effects should be considered so as to exactly compensate for the degradation level of the organic light emitting diode (OLED).

### SUMMARY OF THE INVENTION

Accordingly, an aspect of the present invention is designed to solve such drawbacks of the prior art, and therefore provides an organic light emitting display that includes a temperature sensor and is capable of displaying an image having uniform luminance regardless of the degradation of organic light emitting diodes caused by temperature effects. This can be achieved by providing correction data to compensate for the degradation of organic light emitting diodes caused by temperature changes in a panel by obtaining information of the temperature through a temperature sensor, and a driving method thereof.

An aspect of the present invention is achieved by providing an organic light emitting display including a pixel unit including a plurality of pixels arranged at intersecting points of data lines, scan lines and light emitting control lines; a temperature sensor provided to measure a temperature of the pixel unit; a first analog/digital converter (first ADC) to convert information on the temperature measured in the temperature sensor into a digital value; a controller to receive the digital value outputted from the first ADC and outputting a control signal corresponding to the received digital value; a sensing unit to extract a degradation level of an organic light emitting diode included in each of the pixels; a second analog/digital converter (second ADC) to receive information of the degradation of the organic light emitting diode extracted from the sensing unit and a control signal outputted from the controller and generating a digital value corresponding to the information on the degradation of the organic light emitting diode that is varied according to the temperature; a conversion unit to convert an input data (Data) into a correction data (Data′) so as to display an image having uniform luminance regardless of the changes in the degradation level of the organic light emitting diode due to temperature, by using the digital value outputted from the second ADC; a data driver to receive the correction data (Data′) outputted from the conversion unit and generating data signals to be supplied to the pixels.

According to another aspect of the present invention, the sensing unit includes a sensing circuit arranged in each of channels, wherein the sensing circuit includes a first current source unit to supply a predetermined electric current into an organic light emitting diode in the pixel; and a switching element provided between the current source unit and the data lines corresponding respectively to the channels, and the predetermined electric current has a value (Imax) of an electric current that flows in the organic light emitting diode (OLED) when the pixel is allowed to emit the light with the maximum luminance.

According to another aspect of the present invention, the second ADC includes a (j*k)bit resistor string; a (j*k)bit switch array to select some region from the resistor string by the control signal supplied from the controller and to provide information on a predetermined reference voltage (Vref) corresponding to the temperature measured in the temperature sensor; a comparator to receive information on the reference voltage outputted by the switch array and information on the degradation of the organic light emitting diode outputted from the sensing circuit provided in each of the channels of the sensing unit, that is to say, a voltage of the organic light emitting diode and comparing capacities of the received information to output a predetermined digital bit value; and a j bit register to sequentially store a bit value outputted from the comparator.

According to another aspect of the present invention, the parameter “j” represents a digital bit number into which the information of the degradation of the organic light emitting diode is finally converted, and the parameter “k” represents a different reference number selected by the measured temperature.

According to another aspect of the present invention, the conversion unit includes a look-up table (LUT) addressed by a signal outputted from the second ADC to generate a certain corrected value; and a frame memory to store the corrected value generated in the look-up table.

According to another aspect of the present invention, there is provided a method of driving an organic light emitting display, the method including: measuring a temperature of a pixel unit including pixels; converting information of the measured temperature into a digital value; outputting a control signal corresponding to the converted digital value; extracting degradation information of the organic light emitting diode included in each of the pixels; receiving the control signal and the extracted degradation information of the organic light emitting diode to generate a digital value corresponding to the degradation information of the organic light emitting diode that varies according to the temperature; converting an input data (Data) into a correction data (Data′) so as to display an image having uniform luminance regardless of the changes in the degradation level of the organic light emitting diode due to temperature effects, by using the generated digital value; and receiving the correction data (Data′) to generate data signals to be supplied to the pixels.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a circuit diagram showing a conventional pixel;

FIG. 2 is a block diagram showing an organic light emitting display according to one exemplary embodiment of the present invention;

FIG. 3 is a circuit diagram showing one exemplary embodiment of the pixel as shown in FIG. 2;

FIG. 4 is a diagram schematically showing a sensing unit as shown in FIG. 2;

FIG. 5 is a diagram schematically showing an internal configuration of a second ADC as shown in FIG. 2;

FIG. 6 is a diagram schematically showing an internal configuration of a conversion unit as shown in FIG. 2; and

FIG. 7 is a block diagram showing one exemplary embodiment of a data driver as shown in FIG. 2.

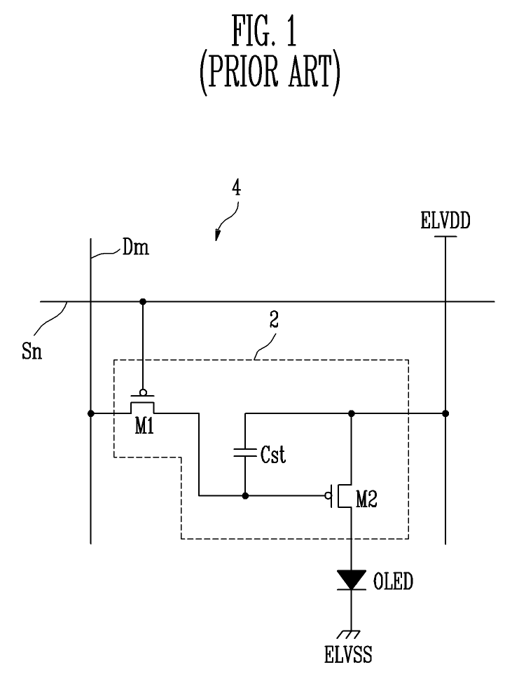

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

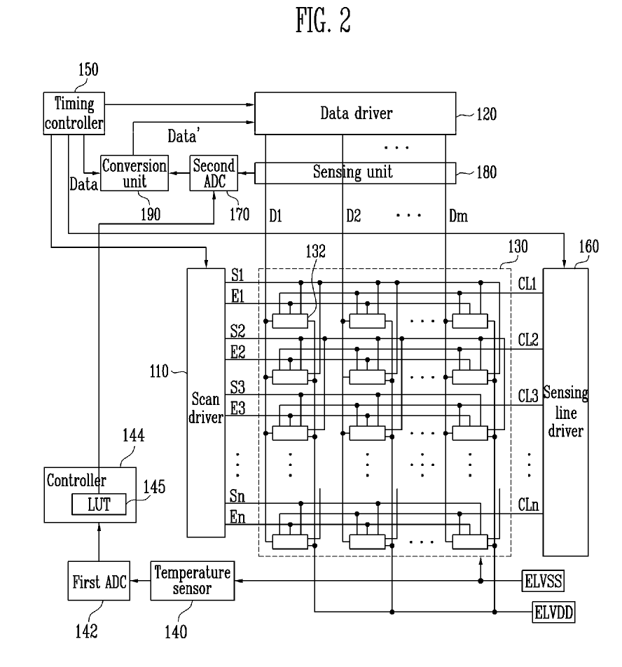

FIG. 2 is a block diagram showing an organic light emitting display according to one exemplary embodiment of the present invention.

Referring to FIG. 2, the organic light emitting display according to one exemplary embodiment of the present invention includes a pixel unit 130, a scan driver 110, a sense line driver 160, a data driver 120, and a timing controller 150. Also, the organic light emitting display according to one exemplary embodiment of the present invention further includes a temperature sensor 140, a first analog/digital converter (hereinafter, referred to as a ‘first ADC’) 142, a controller 144, a sensing unit 180, a second ADC 170, and a conversion unit 190.

In the configuration as described above, the exemplary embodiment of the present invention is characterized in that it provides correction data for compensating for the degradation of organic light emitting diodes caused by changes in temperature in a panel. Information of the degradation caused by the effects of the temperature is measured in the temperature sensor 140.

The pixel unit 130 includes pixels 132 arranged at intersecting points of scan lines (S1 to Sn), light emitting control lines (E1 to En), sense lines (CL1 to CLn) and data lines (D1 to Dm). The pixels 132 are connected to a first power source (ELVDD) and a second power source (ELVSS). The pixels 132 control the current capacity which corresponds to a data signal, the current being supplied from the first power source (ELVDD) to the second power source (ELVSS) via the organic light emitting diodes. The light having a predetermined luminance is generated in the organic light emitting diodes.

The scan driver 110 supplies a scan signal to the scan lines (S1 to Sn) under the control of the timing controller 150. Also, the scan driver 110 supplies a light emitting control signal to the light emitting control lines (E1 to En) under the control of the timing controller 150. Therefore, the scan driver 110 drives the scan lines (S1 to Sn) and the light emitting control lines (E1 to En).

The sense line driver 160 drives the sense lines (CL1 to CLn) by supplying a sensing signal to the sense lines (CL1 to CLn) under the control of the timing controller 150.

The data driver 120 drives the data lines (D1 to Dm) by supplying a data signal to the data lines (D1 to Dm) also under the control of the timing controller 150.

The temperature sensor 140 is coupled to the second power source (ELVSS), and functions to measure a temperature of the pixel unit 130.

Also, the first ADC 142 functions to convert information of the temperature measured in the temperature sensor 140 into a digital value, and the information of the temperature converted into the digital value is inputted into the controller 144.

The controller 144 functions to receive a digital value outputted from the first ADC 142 and outputs a control signal corresponding to the received digital value. Here, the controller 144 includes a look-up table (LUT) 145.

More particularly, the controller 144 selects a predetermined control signal, which corresponds to the information of the received temperature, out of a plurality of control signals previously stored in the LUT 145, and outputs the selected control signal. The control signal outputted from the controller 144 is inputted into the second ADC 170.

The sensing unit 180 obtains information of the degradation level of the organic light emitting diode included in each of the pixels 132. For this purpose, the sensing unit 180 supplies a predetermined electric current to the organic light emitting diode in each of the pixels 132, and measures voltages of the respective organic light emitting diodes generated by the electric current. Therefore, the sensing unit 180 obtains the degradation level of the organic light emitting diode.

That is to say, the degradation level of the organic light emitting diodes may be obtained through the voltage of the organic light emitting diode corresponding to the predetermined electric current. The voltage of the organic light emitting diode is inputted into the second ADC 170.

However, the voltage of the organic light emitting diode, which corresponds to the degradation level, e.g., a predetermined electric current of the organic light emitting diode, may be varied according to the changes in temperature. Therefore, the effects of temperature should be considered so as to exactly compensate for the degradation level of the organic light emitting diode.

Here, the extraction of the degradation information of the organic light emitting diodes is preferably carried out for a non-display period prior to displaying an image after a power source is applied to the organic light emitting display. That is, the degradation information of the organic light emitting diodes may be obtained whenever the power source is applied to the organic light emitting display.

The second ADC 170 receives a control signal outputted from the controller 144 and the degradation information of the organic light emitting diode outputted from the sensing unit 180, i.e., a voltage of the organic light emitting diode corresponding to a predetermined electric current. Accordingly, the second ADC 170 generates a digital value corresponding to the information on the degradation of the organic light emitting diode that is varied due to temperature.

That is, the second ADC 170 may generate a digital value corresponding to the information on the degradation of the organic light emitting diode, which is varied according to temperature, by receiving a control signal provided by the controller 144 in consideration of the information on the temperature measured in the temperature sensor 140 and by receiving information of the degradation of the organic light emitting diode output by the sensing unit 180.

Accordingly, the conversion unit 190 converts input data (Data) from the timing controller 150 into a correction data (Data′) so as to display an image having uniform luminance regardless of the changes in the degradation level of the organic light emitting diode due to temperature effects, by using the digital value outputted from the second ADC.

The timing controller 150 controls the data driver 120, the scan driver 110, and the sense line driver 160.

Also, the data (Data) which is outputted by the timing controller 150 is converted into the correction data (Data′) by the conversion unit 190 by using the digital value outputted from the second ADC so as to compensate for the degradation of the organic light emitting diodes, and then supplied to the data driver 120. Then, the data driver 120 generates a data signal using the converted correction data (Data′), and supplies the generated data signal to the pixels 132.

FIG. 3 shows one exemplary embodiment of the pixel shown in FIG. 2. For convenience of the description the pixel is shown coupled to an mth data line (Dm) and an nth scan line (Sn).

Referring to FIG. 3, the pixel 132 according to one exemplary embodiment of the present invention includes an organic light emitting diode (OLED) and a pixel circuit 135 to supply an electric current to the organic light emitting diode (OLED).

An anode electrode of the light emitting diode (OLED) is coupled to the pixel circuit 135, and a cathode electrode is coupled to the second power source (ELVSS). Such an organic light emitting diode (OLED) generates the light having a predetermined luminance to correspond to an electric current supplied from the pixel circuit 135.

The pixel circuit 135 receives a data signal supplied to the data line (Dm) when a scan signal is supplied to the scan line (Sn). Also, the pixel circuit 135 supplies the information of the degradation of the organic light emitting diode (OLED) to the sensing unit 180 when a sense signal is supplied to the sense line (CLn). For this purpose, the pixel circuit 135 includes 4 transistors (M1 to M4) and one capacitor (C1).

A gate electrode of the first transistor (M1) is coupled to the scan line (Sn), and a first electrode is coupled to the data line (Dm). A second electrode of the first transistor (M1) is coupled to a first node (A).

A gate electrode of the second transistor (M2) is coupled to the first node (A), and a first electrode is coupled to the first power source (ELVDD).

Also, a capacitor (C1) is coupled between the first power source (ELVDD) and the first node (A).

The second transistor (M2) controls the current capacity to correspond to the voltage value stored in the capacitor (C1), the current flowing from the first power source (ELVDD) to the second power source (ELVSS) via the organic light emitting diode (OLED). At this time, the organic light emitting diode (OLED) generates light corresponding to the current capacity supplied from the second transistor (M2).

A gate electrode of the third transistor (M3) is coupled to the light emitting control line (En), and a first electrode of the third transistor (M3) is coupled to the second electrode of the second transistor (M2). A second electrode of the third transistor (M3) is coupled to the organic light emitting diode (OLED). The third transistor (M3) is turned off when a light emitting control signal is supplied to the light emitting control line (En) (at a high level), and turned on when a light emitting control signal is supplied to the light emitting control line (En) (at a low level). Here, the light emitting control signal is supplied to the capacitor (C1) for a period (a programming period) to charge a voltage corresponding to the data signal and a period (an OLED degradation sensing period) for sensing information on the degradation of the organic light emitting diode (OLED).

A gate electrode of the fourth transistor (M4) is coupled to the sense line (CLn), and a first electrode is coupled to an anode electrode of the organic light emitting diode (OLED). Also, a second electrode of the fourth transistor (M4) is coupled to the data line (Dm). Such a fourth transistor (M4) is turned on when a sense signal is supplied to the sense line (CLn), and turned off in all other cases. Here, the sense signal is supplied for a period (an OLED degradation sensing period) for sensing information on the degradation of the organic light emitting diode (OLED).

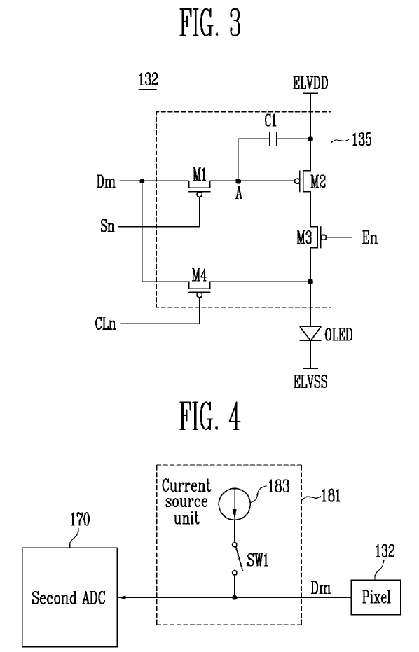

FIG. 4 is a diagram schematically showing a sensing unit as shown in FIG. 2.

Referring to FIG. 4, each of the channels in the sensing unit 180 includes a sensing circuit 181, and the sensing circuit 181 includes a current source unit 183 and a switching element (SW1) coupled to the current source unit 183.

The first current source unit 183 supplies a first electric current (I_{ref}) to the pixels 132 when a switching element (SW1) is turned on. That is to say, the first electric current is supplied to the organic light emitting diodes (OLED) included in the pixels 132, and a predetermined voltage generated in the organic light emitting diode of each of the pixels 132 is supplied to the second ADC 170 when the first electric current is supplied to the pixels 132. At this time, the predetermined voltage (a first voltage) generated by the first current source unit 183 has information on the degradation level of the organic light emitting diodes (OLED).

An internal resistance value of the organic light emitting diode (OLED) is changed according to the degradation of the organic light emitting diode (OLED). That is, a voltage value is changed, the voltage value being generated by the electric current that is applied to correspond to the degradation of the organic light emitting diode. Therefore, it is possible to obtain the degradation information of the organic light emitting diode (OLED) using the changed voltage value.

Meanwhile, an electric current value of the first electric current is set so that a predetermined voltage can be applied to the organic light emitting diode (OLED) within a predetermined time. For example, the first electric current may be set to a value (Imax) of an electric current that should flow in the organic light emitting diode (OLED) when the pixel 132 is allowed to emit the light with the maximum luminance.

FIG. 5 is a diagram schematically showing an internal configuration of a second ADC as shown in FIG. 2.

The second ADC 170 functions to convert the information of the degradation of the organic light emitting diode inputted from the sensing circuit 181, e.g., a voltage of the organic light emitting diode into a digital value. However, this exemplary embodiment of the present invention is characterized in that the digital value is adjusted according to the control signal provided from the controller 144 so as to reflect that the voltage of the organic light emitting diode is varied due to the changes in temperature.

For this purpose, the second ADC 170 includes a (j*k)bit resistor string of (j*k)bit R-string) 172, a (j*k)bit switch array 174, a comparator 176, and a (j*k)bit register 178. Here, the (j*k)bit switch array 174 selects some region out of the resistor string 172 by the control signal supplied from the controller 144, and provides information on a predetermined reference voltage (Vref) that corresponds to the temperature measured in the temperature sensor 140. The comparator 176 receives the information on the reference voltage outputted by the switch array 174 and information on the degradation of the organic light emitting diode outputted from the sensing circuit 181, e.g., a voltage of the organic light emitting diode, and compares capacities of the received information to output a predetermined digital bit value. Also, the bit values outputted from the comparator 176 are sequentially stored in the j bit register 178.

For example, an operation of the second ADC 170 will be described in more detail, on the assumption that a parameter j is 8 and a parameter k is 5.

When the parameter j is 8 degradation information of the organic light emitting diode is converted into an 8bit digital value, and when the parameter k is 5, five different reference values for the temperature measured in the temperature sensor 140 are provided.

Therefore, this exemplary embodiment of the present invention is characterized in that, when the degradation information of the organic light emitting diode is converted into the 8bit digital value, the second ADC 170 selects one of the five reference values based on the temperature measured by the temperature sensor so as to reflect the degradation information affected by the temperature.

That is, the second ADC 170 selects some region of the resistor string 172 by one of the five reference values based on the temperature measured by the temperature sensor, and provides the information on the predetermined reference voltage (Vref) corresponding to the measured temperature. The second ADC 170 receives the information of the reference voltage and the information on the degradation of the organic light emitting diode outputted from the sensing circuit 181, e.g., a voltage of the organic light emitting diode, compares capacities of the received information generates an 8bit digital bit value, and stores the generated 8bit digital bit value.

In this case, the second ADC 170 according to one exemplary embodiment of the present invention includes an (8*5)bit resistor string 172 so as to generate an 8bit digital bit value, depending on the five different reference values according to temperature. An (8*5)bit switch array 174 selects some region of the resistor string 172 through the control signal provided from the controller 144, and provides information on the predetermined reference voltage (Vref) corresponding to the temperature measured in the temperature sensor 140.

As described above, to provide the information on the reference voltage (Vref) corresponding to the measured temperature is to select some region of the resistor string 172 corresponding to the reference voltage through the switch array 174. When some region of the resistor string is selected, the corresponding information of the reference voltage is provided by the selected resistor string.

As described above, the information of the reference voltage outputted by the switch array 174 is inputted into the comparator 176 together with the information of the degradation of the organic light emitting diode, e.g., a voltage of the organic light emitting diode outputted from the sensing circuit 181. Capacities of the information of the reference voltage and the voltage of the organic light emitting diode, both of which are inputted into the comparator 176, are compared by the comparator 176, and then outputted as an 8bit digital bit value.

At this time, the outputted 8bit digital value becomes a digital value corresponding to the information of the degradation of the organic light emitting diode that varies according to the temperature.

As described above, the 8bit digital values outputted from the comparator 176 are sequentially stored in the 8bit register 178, and the stored digital value is provided to the conversion unit 190.

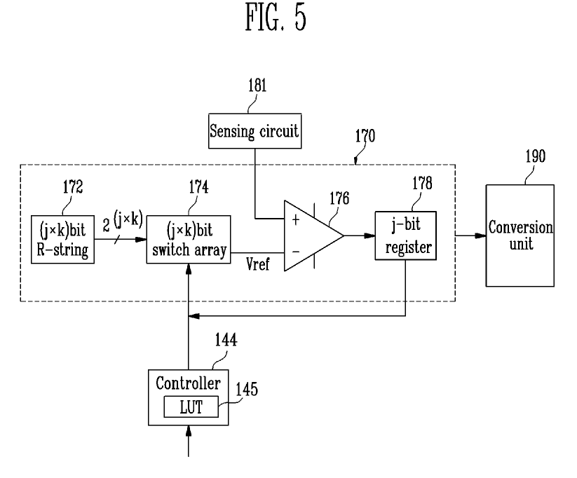

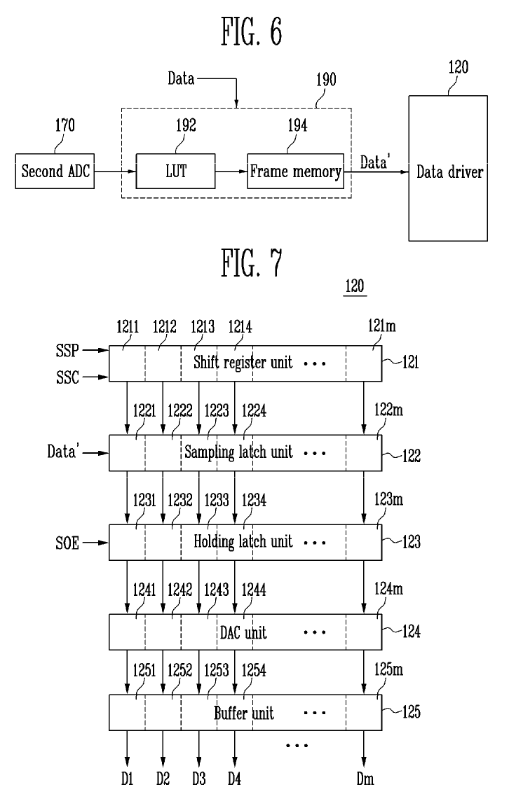

FIG. 6 is a diagram schematically showing an internal configuration of a conversion unit shown in FIG. 2.

The conversion unit 190 converts input data (Data) from the timing controller 150 into correction data (Data′) so as to display an image with uniform luminance regardless of the changes in the degradation level of the organic light emitting diodes due to changes in temperature. This is done by using the digital value outputted from the second ADC 170, e.g., the digital value corresponding to the information on the degradation of the organic light emitting diode that reflects the changes in temperature. Here, the correction data (Data′) converted in the conversion unit 190 is supplied to the data driver 120, and finally supplied to each of the pixels 140 in the panel.

More particularly referring to FIG. 6, the conversion unit 190 includes a look-up table (LUT) 192 and a frame memory 194.

Here, the look-up table (LUT) 192 is addressed by a signal outputted from the second ADC 170 to generate a certain corrected value. The corrected value generated in the look-up table 192 is stored in the frame memory 194.

That is, the conversion unit 190 receives a digital value outputted from the second ADC 170, and converts an input data (Data) into a correction data (Data′) through the look-up table 192 and the frame memory 194 so as to display an image with uniform luminance regardless of the degradation level of the organic light emitting diodes provided in each of the pixels. The correction data (Data′) converted in the conversion unit 190 is supplied to the data driver 120, and finally supplied to the data driver 120.

FIG. 7 is a block diagram showing one exemplary embodiment of the data driver shown in FIG. 2.

Referring to FIG. 7, the data driver 120 includes a shift register unit 121, a sampling latch unit 122, a holding latch unit 123, a DAC unit 124, and a buffer unit 125.

The shift register unit 121 receives a source start pulse (SSP) and a source shift clock (SSC) from the timing controller 150. The shift register unit 121 receiving the source shift clock (SSC) and the source start pulse (SSP) sequentially generates an m-numbered sampling signal while shifting a source start pulse (SSP) in every one cycle of the source shift clock (SSC). For this purpose, the shift register unit 121 includes m-numbered shift registers (1211 to 121m).

The sampling latch unit 122 sequentially stores the correction data (Data′) in response to the sampling signal sequentially supplied from the shift register unit 121. For this purpose, the sampling latch unit 122 includes m-numbered sampling latch 1221 to 122m so as to store m-numbered correction data (Data′).

The holding latch unit 123 receives a source output enable (SOE) signal from the timing controller 150. The holding latch unit 123 receiving the source output enable (SOE) signal receives a correction data (Data′) from the sampling latch unit 122, and stores the received correction data (Data′). The holding latch unit 123 supplies the correction data (Data′) stored in the holding latch unit 123 to the DAC unit 124. For this purpose, the holding latch unit 123 includes m-numbered holding latches 1231 to 123m.

The DAC unit 124 receives the correction data (Data′) from the holding latch unit 123, and generates m-numbered data signals to correspond to the received correction data (Data′). For this purpose, the DAC unit 124 includes m-numbered digital/analog converters (DAC) 1241 to 124m. The DAC unit 124 generates m-numbered data signals using the DACs 1241 to 124m arranged in every channel, and supplies the generated data signals into the buffer unit 125.

The buffer unit 125 supplies the m-numbered data signals supplied from the DAC unit 124 into each of the m-numbered data lines (D1 to Dm). For this purpose, the buffer unit 125 includes m-numbered buffers 1251 to 125m.

According to the exemplary embodiment of the present invention described above, the organic light emitting display of the present invention may display an image having uniform luminance regardless of the changes in the degradation level of the organic light emitting diode due to changes in temperature.

While an aspect of the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a pixel unit including a plurality of pixels disposed at intersecting points of data lines, scan lines and light emitting control lines;
a temperature sensor provided to measure a temperature of the pixel unit;
a first analog/digital converter (first ADC) to convert temperature information measured by the temperature sensor into a first digital value;
a controller to receive the first digital value outputted from the first ADC and to output a control signal corresponding to the received first digital value;
a sensing unit to extract information of a degradation level of an organic light emitting diode included in each of the pixels;
a second analog/digital converter (second ADC) to receive the information of the degradation level of the organic light emitting diode extracted from the sensing unit and the control signal outputted from the controller and to generate a second digital value corresponding to the information of the degradation level of the organic light emitting diode and the temperature of the pixel unit;
a conversion unit to convert an input data (Data) into a correction data (Data′) so as to display an image having uniform luminance regardless of the degradation level of the organic light emitting diode according and the temperature of the pixel unit, by using the second digital value outputted from the second ADC; and
a data driver to receive the correction data (Data′) outputted from the conversion unit and to generate data signals to be supplied to the pixels.

2. The organic light emitting display according to claim 1, wherein the sensing unit includes a sensing circuit arranged in each of channels, wherein the sensing circuit comprises:
a first current source unit to supply a predetermined electric current into the organic light emitting diode in the pixel; and
a switching element provided between the current source unit and the data lines corresponding respectively to the channels.

3. The organic light emitting display according to claim 2, wherein the predetermined electric current has a value (Imax) of an electric current that flows in the organic light emitting diode (OLED) when the pixel is allowed to emit the light with the maximum luminance.

4. The organic light emitting display according to claim 1, wherein the second ADC comprises:
a (j*k)bit resistor string;
a (j*k)bit switch array to select some region from the resistor string through the control signal supplied from the controller and to provide information on a predetermined reference voltage (Vref) corresponding to the temperature measured in the temperature sensor;
a comparator to receive information on the reference voltage outputted by the switch array and information on the degradation level of the organic light emitting diode outputted from the sensing circuit provided in each of the channels of the sensing unit, and to compare capacities of the received information to output a predetermined digital bit value; and
a j bit register to sequentially store a bit value outputted from the comparator.

5. The organic light emitting display according to claim 4, wherein parameter “j” represents a digital bit number into which the information on the degradation level of the organic light emitting diode is finally converted, and parameter “k” represents a different reference number selected by the measured temperature.

6. The organic light emitting display according to claim 1, wherein the conversion unit comprises:
a look-up table (LUT) addressed by a signal outputted from the second ADC to generate a certain corrected value; and
a frame memory to store the corrected value generated in the look-up table.

7. The organic light emitting display according to claim 1, wherein the data driver includes a shift register unit, a sampling latch unit, a holding latch unit, a digital/analog converting (DAC) unit and a buffer unit.

8. The organic light emitting display according to claim 8, wherein the shift register unit receives a source start pulse (SSP) and a source shift clock (SSC) from a timing controller and sequentially generates an m-numbered sampling signal while shifting a source start pulse (SSP) in each one cycle of the source shift clock (SSC).

9. The organic light emitting display according to claim 7, wherein the shift register unit includes m-numbered shift registers for sequentially generating the m-numbered sampling signal.

10. The organic light emitting display according to claim 8, wherein the sampling latch unit sequentially stores the correction data (Data′) in response to the m-numbered sampling signal sequentially supplied from the shift register unit.

11. The organic light emitting display according to claim 11, wherein the sampling latch unit includes m-numbered sampling latches so as to store m-numbered correction data (Data′).

12. The organic light emitting display according to claim 10, wherein the holding latch unit receives a source output enable (SOE) signal from the timing controller and receives the correction data (Data′) from the sampling latch unit, and supplies the Data′ to the DAC unit.

13. The organic light emitting display according to claim 12, wherein the holding latch unit includes m-numbered holding latches for storing the Data′.

14. The organic light emitting display according to claim 12, wherein the DAC unit receives the Data′ from the holding latch unit, and generates m-numbered data signals to correspond to the received Data′.

15. The organic light emitting display device according to claim 14, wherein the DAC unit includes m-numbered digital/analog converters arranged in each channel, which generate m-numbered data signals and supply the generated m-numbered data signals to the buffer unit.

16. The organic light emitting display device according to claim 15, wherein the buffer unit supplies the m-numbered data signals to the data lines.

17. A method of driving an organic light emitting display, the method comprising:
measuring a temperature of a pixel unit including a plurality of pixels;
converting information of the measured temperature into a first digital value;
outputting a control signal corresponding to the converted first digital value;
extracting information of the degradation of the organic light emitting diode included in each of the pixels;
receiving the control signal and the extracted information of the degradation of the organic light emitting diode to generate a second digital value corresponding to the information of the degradation of the organic light emitting diode that is varied according to temperature;
converting an input data (Data) into a correction data (Data′) so as to display an image having uniform luminance regardless of changes in the degradation level of the organic light emitting diode according to temperature, by using the generated second digital value; and
receiving the correction data (Data′) to generate data signals to be supplied to the pixels.

18. The method of driving the organic light emitting display according to claim 17, wherein the extracting information of the degradation of the organic light emitting diode included in each of the pixels comprises:
supplying a first electric current to the organic light emitting diode included in the each of the pixels; and
measuring a first voltage generated in the organic light emitting diode through the application of the first electric current.

19. The method of driving the organic light emitting display according to claim 17, wherein the receiving of the control signal and the extracted information of the degradation of the organic light emitting diode to generate a second digital value corresponding to the information on the degradation of the organic light emitting diode that is varied according to temperature comprises:
selecting some region from a (j*k)bit resistor string through the control signal to provide information on a predetermined reference voltage (Vref) corresponding to the measured temperature;
receiving the information on the reference voltage and the information on the degradation of the organic light emitting diode and comparing capacities of the received information to output a predetermined digital bit value; and
generating a digital value of j bits corresponding to the information of the degradation of the organic light emitting diode that is varied according to temperature by sequentially storing the outputted bit value.

20. The method of driving the organic light emitting display according to claim 19, wherein parameter “j” represents a digital bit number into which the information of the degradation of the organic light emitting diode is finally converted, and parameter “k” represents a different reference number selected by the measured temperature.

21. A method of driving an organic light emitting display, the method comprising:
obtaining temperature information of a pixel unit including a plurality of pixels;
converting the temperature information into a first digital value;
outputting a control signal corresponding to the first digital value;
obtaining degradation information of an organic light emitting diode included in each of the pixels;
converting input data (Data) into a correction data (Data′) using the control signal and the second digital data value; and
generating data signals to be supplied to the pixels using the correction data (Data′).
